(19) United States
(12) Patent Application Publication
(10) Pub. No.: US 2008/0180746 A1
(43) Pub. Date: Jul. 31, 2008

(54) IMAGE PROCESSING DEVICE

(75) Inventor: Hiroshi Morisaki, Kitanagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/022,691

(22) Filed: Jan. 30, 2008

(30) Foreign Application Priority Data
Jan. 31, 2007 (JP) 2007-022009

(51) Int. Cl. G06F 15/00

(52) U.S. Cl. 358/1.16; 358/1.1

(57) ABSTRACT

A mounting portion detachably mounts an external storage medium storing image data. An image processing portion performs a predetermined image process on the image data. A normal processing portion performs a normal process other than the predetermined image process. A detecting portion detects that the external storage medium is mounted in the mounting portion. An image-process instructing portion instructs the image processing portion to start the predetermined image process if the detecting portion detects that the external storage medium is mounted. A normal-process instructing portion instructs the normal processing portion to start the normal process. The control portion instructs the image processing portion to halt the predetermined image process and instructs the normal processing portion to start the normal process, if the normal-process instructing portion instructs the normal processing portion to start the normal process during a time that the image processing portion is performing the predetermined image process.

### CROSS REFERENCE TO RELATED APPLICATIONS

This application claims priority from Japanese Patent Application No. 2007-022009 filed Jan. 31, 2007. The entire content of the priority application is incorporated herein by reference.

### TECHNICAL FIELD

The invention relates to an image processing device and a computer readable product storing program instructions for controlling an image processing device.

### BACKGROUND

Recently, resolution of an image captured by a digital camera has become higher and data size of the image has become larger. In order to perform sophisticated image processing on such a large-sized image, a considerable amount of time is required.

Japanese Patent Application Publication No. 2006-110817 discloses the method in which image processing is automatically started when a storage media storing image data is mounted.

However, with this conventional technique, processing instructed by the user is delayed or cannot be performed at all when image processing is started automatically.

### SUMMARY

In view of the foregoing, it is an object of the invention to provide an image processing device and a program for controlling an image processing device capable of obtaining processed image data quickly and capable of responding to a user's request promptly.

In order to attain the above and other objects, the invention provides an image processing device. The image processing device includes a mounting portion, an image processing portion, a normal processing portion, a detecting portion, an image-process instructing portion, a normal-process instructing portion, and a control portion. The mounting portion is configured to detachably mount an external storage medium storing image data. The image processing portion performs a predetermined image process on the image data stored in the external storage medium. The normal processing portion performs a normal process other than the predetermined image process. The detecting portion detects that the external storage medium is mounted in the mounting portion. The image-process instructing portion instructs the image processing portion to start the predetermined image process if the detecting portion detects that the external storage medium is mounted in the mounting portion. The normal-process instructing portion instructs the normal processing portion to start the normal process. The control portion instructs the image processing portion to halt the predetermined image process and instructs the normal processing portion to start the normal process, if the normal-process instructing portion instructs the normal processing portion to start the normal process during a time that the image processing portion is performing the predetermined image process.

According to another aspect, the invention also provides a computer readable product storing a set of program instructions executable on an image processing device. The set of program instructions includes: detecting that an external storage medium is mounted on an image processing device; instructing start of a predetermined image process on image data stored in the external storage medium if the external storage medium is mounted; performing the predetermined image process; detecting that start of a normal process is instructed, the normal process being other than the predetermined image process; and halting the predetermined image process and starting the normal process, if the start of the normal process is instructed during a time that the predetermined image process is being performed.

### BRIEF DESCRIPTION OF THE DRAWINGS

Embodiments in accordance with the invention will be described in detail with reference to the following figures wherein:

FIG. 1 is a perspective view showing the appearance of a multifunction peripheral according to an embodiment of the invention;

FIG. 2 is a block diagram showing the electrical configuration of the multifunction peripheral;

FIGS. 3A through 3E illustrate screen patterns that are displayed on a display screen, wherein FIG. 3A shows a menu selection screen, FIG. 3B shows a general setting screen, FIG. 3C shows an image selection screen, FIG. 3D shows a mode selection screen, and FIG. 3E shows a number-of-sheet input screen;

FIG. 4 is a flowchart showing a part of a main task executed on the multifunction peripheral;

FIG. 5 is a flowchart showing another part of the main task;

FIG. 6 is a flowchart showing an image processing task executed on the multifunction peripheral;

FIG. 7 is a flowchart showing a print setting process executed on the multifunction peripheral; and

FIG. 8 is a flowchart showing a print execution process executed on the multifunction peripheral.

### DETAILED DESCRIPTION

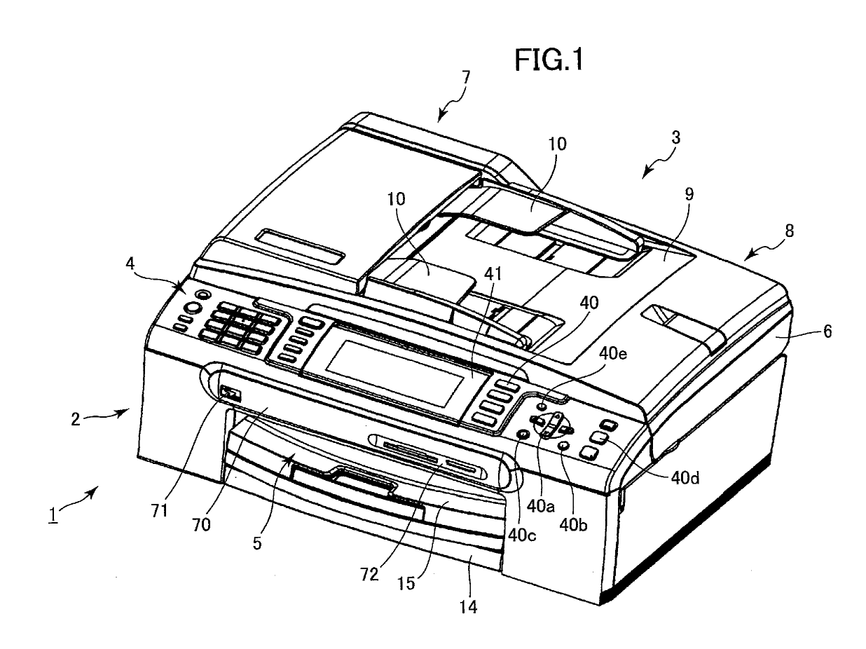

An image processing device and a program for controlling an image processing device according to some aspects of the invention will be described while referring to FIGS. 1 through 8. The image processing device of the embodiment is applied to a multifunction peripheral.

FIG. 1 is a perspective view showing the appearance of a multifunction peripheral or multifunction printer (hereinafter referred to as an “MFP”) 1 according to the embodiment. As shown in FIG. 1, the MFP 1 includes a printer 2 provided in a lower portion of the MFP 1; a scanner 3 provided in an upper portion of the MFP 1; and an operation panel 4 provided at the front of the MFP 1 and adjacent to the scanner 3. The MFP 1 operates as a printer, a scanner, a copier, and a facsimile machine.

The MFP 1 can be connected to a computer (not shown). The MFP 1 prints images or texts on a recording sheet (medium on which printing is executed), based on image data or text data transmitted from the computer. The MFP 1 can also be connected to an external device such as a digital camera. The MFP 1 prints an image on a recording sheet, based on the image data outputted from the digital camera. Various types of storage media including a memory card can be mounted in the MFP 1. The MFP 1 executes printing on a recording sheet, based on the image data stored in a storage medium mounted in the MFP 1.

The scanner 3 includes an original table 6 as a flatbed scanner (FBS); and an original cover 8. The original cover 8 is hingedly secured to the original table 6 so as to open and close about the hinge. The hinge is positioned on the rear side of the original cover 8. The original cover 8 has an automatic document feeding system (ADF: Auto Document Feeder) 7.

The ADF 7 feeds an original (original document) from an original tray 9, to an original discharge tray 10, through an original conveying path. The ADF 7 includes a sensor for detecting the leading end of the original. A conveying amount for conveying an original is controlled by using the position of the leading end detected by the sensor as a reference position.

The printer 2 is an inkjet-type image recording device. The printer 2 prints the image on the recording sheet by selectively ejecting ink droplets onto the sheet based on image data obtained by the scanner 3 or based on image data inputted from an external device. As mentioned above, the printer 2 is positioned below the scanner 3.

An opening 5 is provided at the front of the MFP 1, that is, at the front of the printer 2. A feed tray 14 and a discharge tray 15 are provided within the opening 5. The feed tray 14 and the discharge tray 15 are arranged so as to overlap with each other in the vertical direction. The discharge tray 15 is positioned on the upper side. The feed tray 14 is positioned below the discharge tray 15.

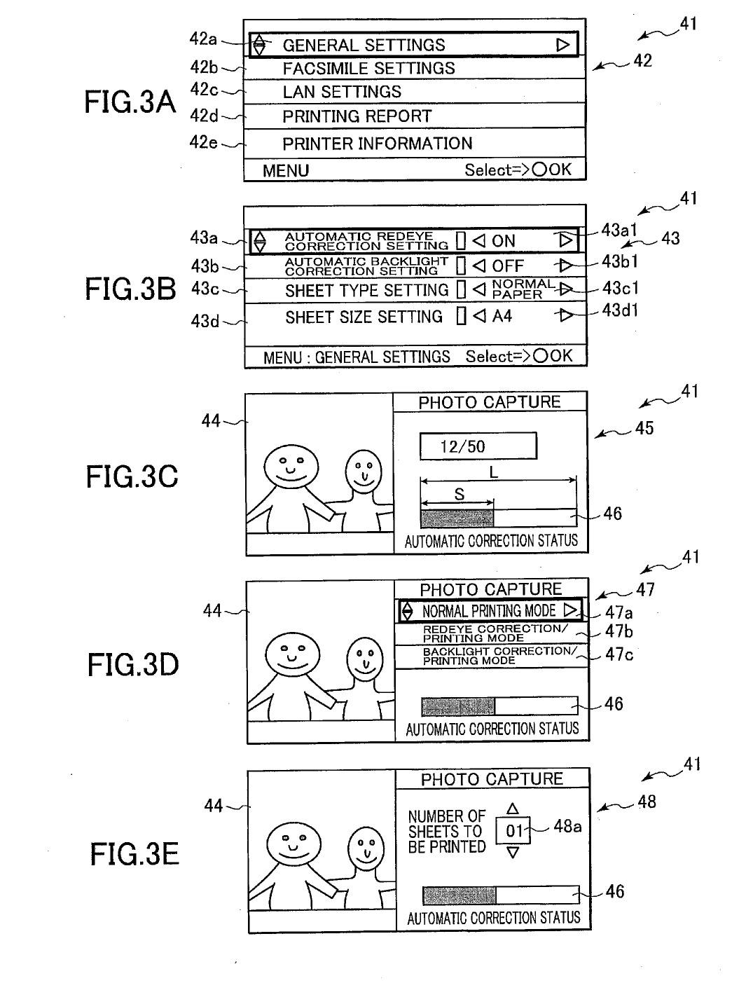

As shown in FIG. 1, a horizontally elongated operation panel 4 is provided also at the front of the MFP 1. A user operates the printer 2 or the scanner 3 via the operation panel 4. The operation panel 4 has various operation keys 40, and a liquid crystal display (LCD) unit 41 (hereinafter, referred to as a “display screen”). The display screen 41 is configured of horizontally arranged two sub-screens having an aspect ratio of 3:4, thereby having an aspect ratio of 3:8 as a whole. The screens to be displayed on the display screen 41 will be described later with reference to FIGS. 3A through 3E.

The user can provide an instruction to the MFP 1 by using the operation panel 4. As a given instruction is inputted, the MFP 1 is controlled based on the inputted instruction. The operation keys 40 of the operation panel 4 include a cursor key 40a, a menu key 40b, an OK key 40c, a start key 40d, and, a delete key 40e.

The cursor key 40a is configured of four keys arranged in a shape of a cross and including: an up arrow key for moving a cursor upward; a down arrow key for moving the cursor downward; a left arrow key for moving the cursor to the left; and a right arrow key for moving the cursor to the right. The menu key 40b is for displaying menu (setting items etc.) on the display screen 41. The OK key 40c is for confirming the setting selected by the cursor key 40a on the display screen 41. The start key 40d is for starting printing. The delete key 40e is for deleting a selected one of image data stored in a memory card 50.

Above the opening 5 of the printer 2, a connection panel 70 is provided. The connection panel 70 has a USB terminal 71 substantially at the left end of the panel. The USB terminal 71 connects an external device to the MFP 1, so as to allow communications between the external device and the MFP 1. The connection panel 70 also has a slot section 72 substantially at the right end of the panel.

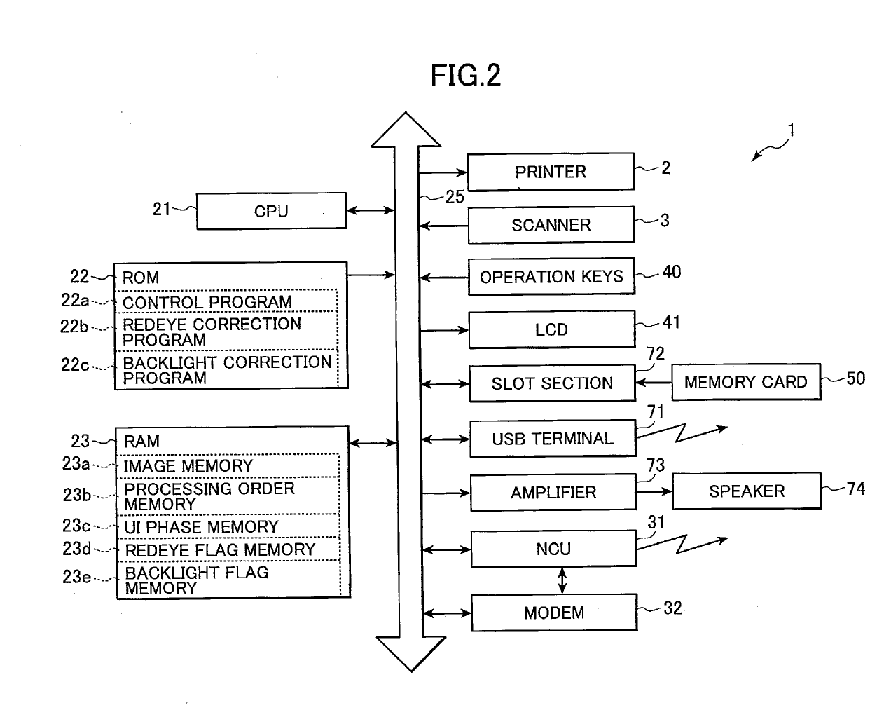

The memory card 50 (see FIG. 2) is detachably mounted in the slot section 72. The slot section 72 has a sensor (not shown) for detecting the presence or absence of the memory card 50. When the sensor determines that the memory card 50 has been mounted, image processing is started on the image data stored in the memory card 50.

An electrical configuration of the MFP 1 will be described with reference to FIG. 2. FIG. 2 is a block diagram showing the electrical configuration of the MFP 1. The MFP 1 includes the printer 2, the scanner 3, a CPU 21, a ROM 22, a RAM 23, a network control unit (hereinafter, referred to as “NCU”) 31, a modem 32, the operation keys 40, an LCD 41, the USB terminal 71, the slot section 72, an amplifier 73, and a speaker 74. These components are connected to each other via a bus line 25.

The CPU 21 controls each of the components connected through the bus line 25. The control is performed according to fixed value data, a program or various signals. The fixed value data and the program are stored in the ROM 22 or the RAM 23. The signals are transmitted or received through the NCU 31. The ROM 22 stores various control programs 22a, a redeye correction program 22b, and a backlight correction program 22c. The control programs 22a are executed in the MFP 1. The redeye correction program 22b and the backlight correction program 22c are executed for image processing.

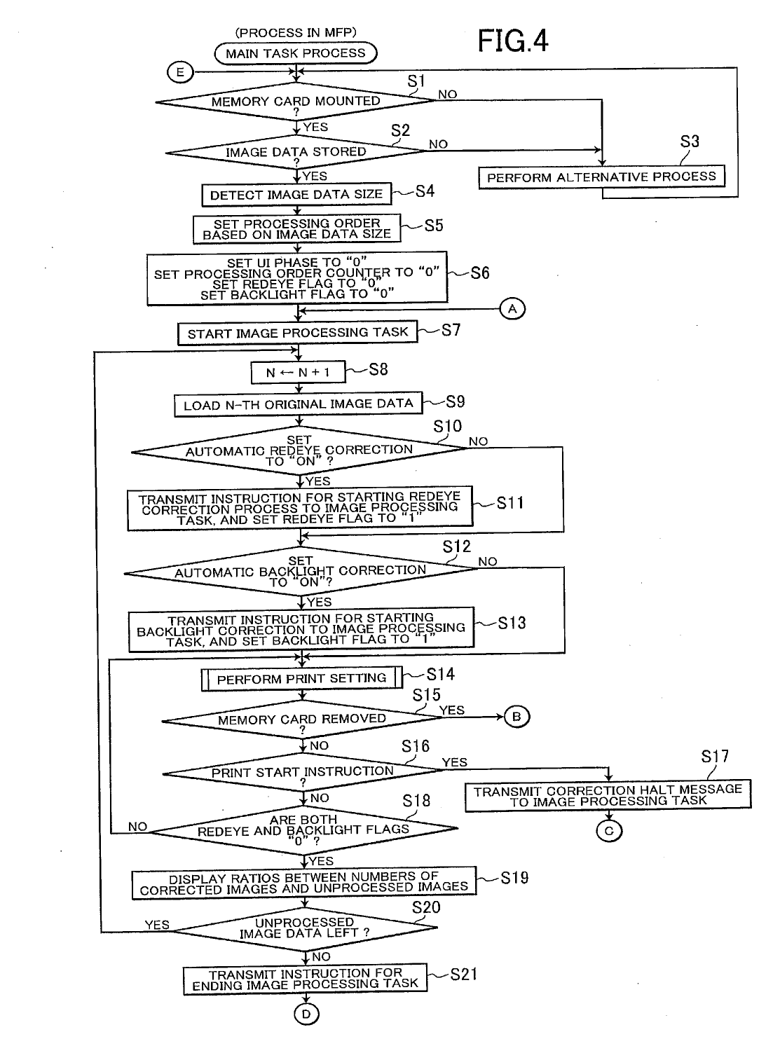

The control programs 22a are executed for the processes shown in FIG. 4 to FIG. 8. The redeye correction program 22b is executed for redeye correction. When a flash is used for taking a photograph at night with a digital camera or the like, a person or an animal on the photograph sometimes has red eyes. This is called a redeye effect. In order to avoid this unpleasant effect, when redeye is detected, the detected redeye is corrected.

The backlight correction program 22b is executed for backlight correction. When a photograph is taken in a backlight condition, dark regions in the photograph tend to be unclear. Examples of backlight correction processing include Retinex image processing. While the redeye and backlight correction techniques have become more advanced, a longer time is required for completing the correction operations due to their technical complexity. An increasing number of pixels owing to a higher-resolution digital camera also causes a longer time required for completing the corrections.

The RAM 23 is a rewritable memory for storing various kinds of data. The RAM 23 includes an image memory 23a, a processing order memory 23b, a UI phase memory 23c, a redeye flag memory 23d, and a backlight flag memory 23e. The image memory 23a stores original image data stored in the memory card 50; the image data redeye-corrected by the redeye correction program 22b; and the image data backlight-corrected by the backlight correction program 22c. Note that image data which has not been redeye-corrected nor backlight-corrected is referred to as “original image data”. Note also that image data which has been redeye-corrected or backlight-corrected is referred to as “processed image data”. The processing order memory 23b stores the order to perform image processing. When the memory card 50 is mounted in the slot section 72, respective data sizes of a plurality of original image data stored in the memory card 50 are detected. The order of image processing is determined according to the data sizes. The filenames of the original image data are stored in the processing order memory 23b in the determined order.

The UI phase memory 23c stores the currently-set UI phase. A UI phase is set through the operation keys 40. The functions of the operation keys 40 and the screens to be displayed on the display screen 41 vary depending on which UI phase has been selected. When the UI phase is set to “0”, the user can select an image. When the UI phase is set to “1”, the user can select which processing is performed on the selected image. When the UI phase is set to “2”, the user can set the number of sheets to be printed. Further description will be given later in detail with reference to FIG. 3.

The redeye flag memory 23a stores a redeye flag. When an instruction is given to start redeye correction, the redeye flag is set to “1”. When redeye correction is completed, the redeye flag is set to “0”. Similarly, the backlight flag memory 23e stores a backlight flag. When an instruction is given to start backlight correction, the backlight flag is set to “1”. When backlight correction is completed, the backlight flag is set to “0”.

The memory card 50 has been mounted in the slot section 72. The image data stored in the memory card 50 can be loaded into the image memory 23a through the slot section 72. The other way round, the image data stored in the image memory 23a can be written into the memory card 50. The memory card 50 is a nonvolatile memory configured of a flash memory, and is mounted in a digital camera for recording images.

The NCU 31 transmits a dial signal to a telephone network (not shown). The NCU 31 also responds to a ringing signal transmitted from the telephone network. The modem 32 modulates or demodulates image data for transmission to or reception from a destination facsimile machine (not shown) through the NCU 31. The modem 32 also transmits or receives various procedure signals for transmission control. The USB terminal 71 is a known circuit for transmitting data to or receiving data from the computer through a USB cable (not shown). The amplifier 73 is connected to a speaker 74. The amplifier 73 drives the speaker 74 to output a ringing tone or the like.

Next, screens displayed on the display screen 41 and functions of the operation keys 40 will be described with reference to FIGS. 3A through 3E. FIGS. 3A through 3E show various screen patterns that are displayed on the display screen 41. FIG. 3A shows a menu screen 42 that is displayed when the user depresses a menu key 40b. The menu screen 42 includes “General Settings” 42a, “Facsimile Settings” 42b, “LAN Settings” 42c, “Printing Report” 42d for displaying or outputting a printing report, and “Printer Information” 42e. One of the items can be selected by moving the cursor to a desired item with the up or down arrow key of the cursor key 40a. The selected item is surrounded with a thick-line frame. FIG. 3A shows an example in which the General Settings 42a, displayed on the top of the menu, is selected. When the user depresses the OK key 40c in this state, the general setting items 43 are displayed on the display screen 41.

FIG. 3B shows the general setting items 43 for the “General Settings” 42a. The general setting items 43 include “automatic redeye correction setting” 43a for selecting whether redeye correction should be performed automatically, “automatic backlight correction setting” 43b for selecting whether backlight correction should be performed automatically, “Sheet Type Setting” 43c for selecting the type of a sheet for printing, and “Sheet Size Setting” 43d for selecting the size of the sheet for printing. One of the items can be selected by moving the cursor to a desired item with the up or down arrow key of the cursor key 40a. The selected item is surrounded with a thick-line frame. FIG. 3B shows an example in which the automatic redeye correction setting 43a displayed on the top of the menu is selected.

For each of the items, an item name is displayed on the left, and options to be selected for the item are displayed on the right. The automatic redeye correction setting 43a is provided to select whether redeye correction is started automatically when the memory card 50 is mounted in the slot section 72. Either one of the setting option 43a1 “ON” or “OFF” is selected by moving the cursor to a desired option with the left or right arrow key of the cursor key 40a, in a state where the automatic redeye correction setting 43a has been selected. FIG. 3B shows an example in which “ON” is selected. If “ON” is selected, a redeye correction process is automatically started when the memory card 50 is mounted in the slot section 72. If “OFF” is selected, redeye correction is not started automatically.

Similarly, the automatic backlight correction setting 43b is provided to select whether backlight correction should be started automatically when the memory card 50 is mounted in the slot section 72. Either one of the setting options 43b1 “ON” or “OFF” can be selected by moving the cursor to a desired option with the left or right arrow key of the cursor key 40a, in a state where the item automatic backlight correction setting 43b is selected. The setting options 43b1 are displayed on the right of the area where the automatic backlight correction setting 43b is displayed. FIG. 3B shows an example in which “OFF” is selected. If “ON” is selected, backlight correction is automatically started when the memory card 50 is mounted in the slot section 72. If “OFF” is selected, backlight correction is not started automatically.

Similarly, the Sheet Type Setting 43c is provided to select any one from the sheet type setting options 43c1 “Ordinary Paper”, “Glossy Paper”, and the like. This selection is made by moving the cursor to a desired option with the left or right arrow key of the cursor key 40a. FIG. 3B shows an example in which the Ordinary Paper is selected for the item. Similarly, the item Sheet Size Setting 43d is provided to select any one of the sheet size setting options 43d1 “B5”, “A4”, “B4”, and the like. This selection is made by moving the cursor to a desired option with the left or right arrow key of the cursor key 40a. FIG. 3B shows an example in which the “A4” is selected. If the OK key 40c is depressed after these settings have been performed, the selection is confirmed.

With reference to FIGS. 3C, 3D, and 3E, a description is given for the screens displayed on the display screen 41 when the memory card 50 has been mounted in the slot section 72.

Referring to FIG. 3C, an image selection screen 45 is described. FIG. 3C shows the image selection screen 45 to be displayed on the display screen 41 when the UI phase is set to “0”. When the sensor of the slot section 72 determines that the memory card 50 has been mounted in the slot section 72, the UI phase is set to “0”. In a state where the image selection screen 45 is displayed, one of a plurality of original image data stored in the memory card 50 can be selected. On the image selection screen 45, an image is displayed in a left half 44 of the display screen 41 based on the selected original image data. In a right half of the display screen 41, an image number 45a and an automatic correction status indicator 46 are displayed. The image number 45a indicates the number of the currently selected original image data. The automatic correction status indicator 46 indicates a progress status of the automatic image correction which is currently performed.

The image number 45a is given in the form of a fraction, where the denominator is the number of original image data stored in the memory card 50 and the numerator is the number assigned to the currently selected original image data among all the stored original image data. The currently selected number is decreased by depressing the left arrow key of the cursor key 40a in a state where the image selection screen 45 is displayed, whereas the currently selected number is increased by depressing the right arrow key of the cursor key 40a in the same state. FIG. 3C shows an example in which “12/50” appears as the image number 45a, which means that the number of the original image data stored in the currently mounted memory card 50 is fifty, and that the twelfth original image data has been selected among all the stored original image data. The order “twelfth” is based on the order in which the original image data are stored in the memory card 50. The image based on the twelfth original image data is displayed on the left half 44.

The automatic correction status indicator 46 indicates the ratio of the number of the image data on which correction has been completed, relative to the number of all the original image data stored in the memory card 50. When “ON” is selected for the automatic redeye correction setting 43a or the automatic backlight correction setting 43b in a state where the memory card 50 is mounted in the slot section 72, the process specified by “ON” is started on the selected image data. The specified correction process is performed on a plurality of original image data stored in the memory card 50 one at a time. The newly created image data, on which correction has been completed, is stored in the image memory 23a as processed image data. Note that the original image data, which has not been corrected, is stored in the memory card 50.

The ratio of the number of the processed image data relative to the number of all the original image data stored in the memory card 50 is calculated. The calculated ratio is displayed on the automatic correction status indicator 46 in the form of a bar graph. A length S in gray relative to an entire length L of the bar graph indicates a ratio of the correction process progress. For example, the length S pointing to “0” (no gray area) means that no processed image data has been created yet. The length S pointing to the midpoint of the entire length L means that half the number of the entire image data stored in the memory card 50 has been corrected. If the user depresses the OK key 40c in a state where the image selection screen 45 is displayed, the UI phase is set to “1” and a mode selection screen 47 appears on the display screen 41 as shown in FIG. 3D.

The mode selection screen 47 will be described with reference to FIG. 3D. FIG. 3D shows the mode selection screen 47 to be displayed on the display screen 41 when the UI phase has been set to “1”. On the mode selection screen 47, an image is displayed in the left half 44 of the display screen 41, based on the selected image data. In the right half of the display screen 41, the following three modes are displayed: normal printing mode 47a; redeye correction/printing mode 47b; and backlight correction/printing mode 47c. In the normal printing mode 47a, printing is executed based on the original image data stored in the memory card 50. When this mode is selected, an image is printed based on original image data which is neither redeye-corrected nor backlight-corrected.

In the redeye correction/printing mode 47b, printing is executed based on redeye-corrected data, which is obtained by redeye-correcting the selected original image data. When this mode is selected, a search is conducted for redeye-corrected data in the image memory 23a. If any redeye-corrected data is found in the image memory 23a, an image is printed based on the redeye-corrected data. If no redeye-corrected data is found in the image memory 23a, the redeye correction program 22b is started so that redeye correction is performed on the selected original image data. As the redeye correction is completed, the redeye-corrected image is then printed.

Note that each processed image data is stored with a filename (or identifier) that indicates relation with the corresponding original image data. A search is conducted based on the filename. The filename is described later in greater detail.

In the backlight correction/printing mode 47c, printing is executed based on backlight-corrected data, which is obtained by backlight-correcting the selected original image data. When this mode is selected, a search is conducted for backlight-corrected data in the image memory 23a. If any backlight-corrected data is found in the image memory 23a, an image is printed based on the backlight-corrected data. If no backlight-corrected data is found in the image memory 23a, the backlight correction program 22c is started so that backlight correction is performed on the selected original image data. As the backlight correction is completed, the backlight-corrected image is printed.

These modes can be selected by moving the cursor to a desired item with the up or down arrow key of the cursor key 40a. The selected mode is surrounded with a thick-line frame. FIG. 3D shows an example in which the normal printing mode is selected. When the user selects one mode and then depresses the OK key 40c, the selected mode is confirmed. When the user selects one of the modes, the UI phase is set to “2” and a sheet number input screen 48 appears on the display screen 41 as shown in FIG. 3E.

When the UI phase is set to “1”, the selected image data is deleted from the memory card 50 by depressing the delete key 40e. As the user depresses the delete key 40e, the selected original image data is deleted from the memory card 50. At the same time, if the processed image data corresponding to the original image data is stored in the image memory 23a, the corresponding processed image data is also deleted from the image memory 23a. The UI phase is then set to “0”, and the image selection screen 45 appears on the display screen 41.

The sheet number input screen 48 is described with reference to FIG. 3E. FIG. 3E shows the sheet number input screen 48 that is displayed on the display screen 41 when the UI phase has been set to “2”. On the sheet number input screen 48, an image is displayed in the left half 44 of the display screen 41 based on the selected original image data. In the right half of the display screen 41, a number of sheets to be printed 48a and the automatic correction status indicator 46 are displayed. The number of sheets to be printed 48a indicates how many sheets are to be printed. The currently displayed number increases by depressing the up arrow key of the cursor key 40a, whereas the currently displayed number is decreased by depressing the down arrow key. If neither of the keys is depressed, the number of sheets to be printed 48a is set to “1”. When the user depresses the start key 40d, printing is started. Upon completion of printing, the UI phase is set to “0”, and the image selection screen 45 appears on the display screen 41. At this time, the image which has been printed is displayed on the left half 44 of the display screen 41. Alternatively, the image to be printed next may be displayed.

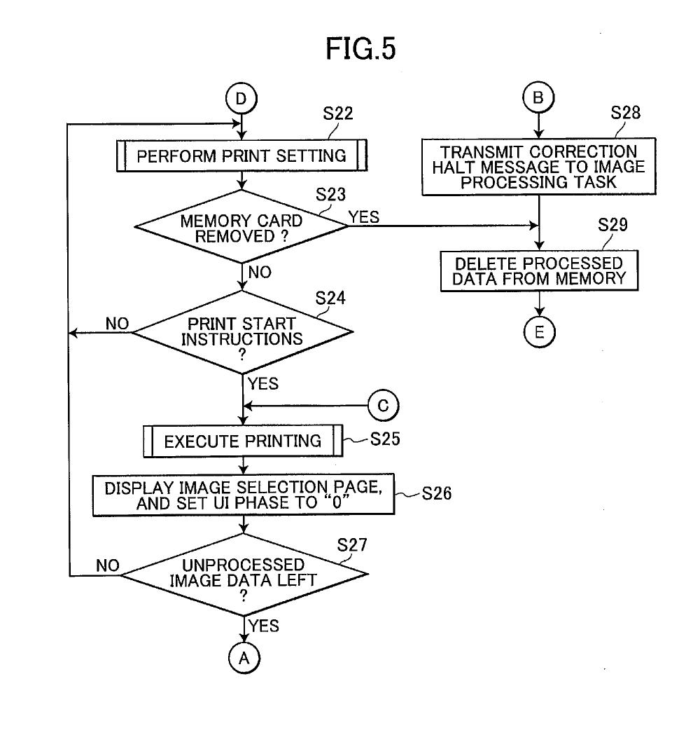

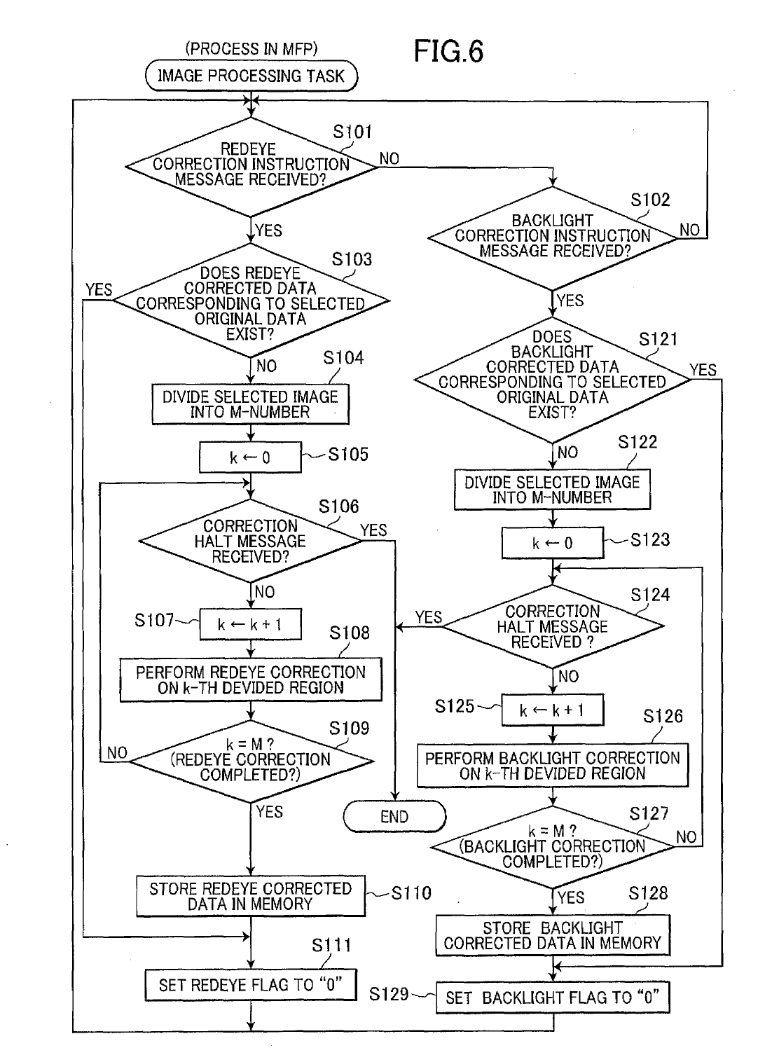

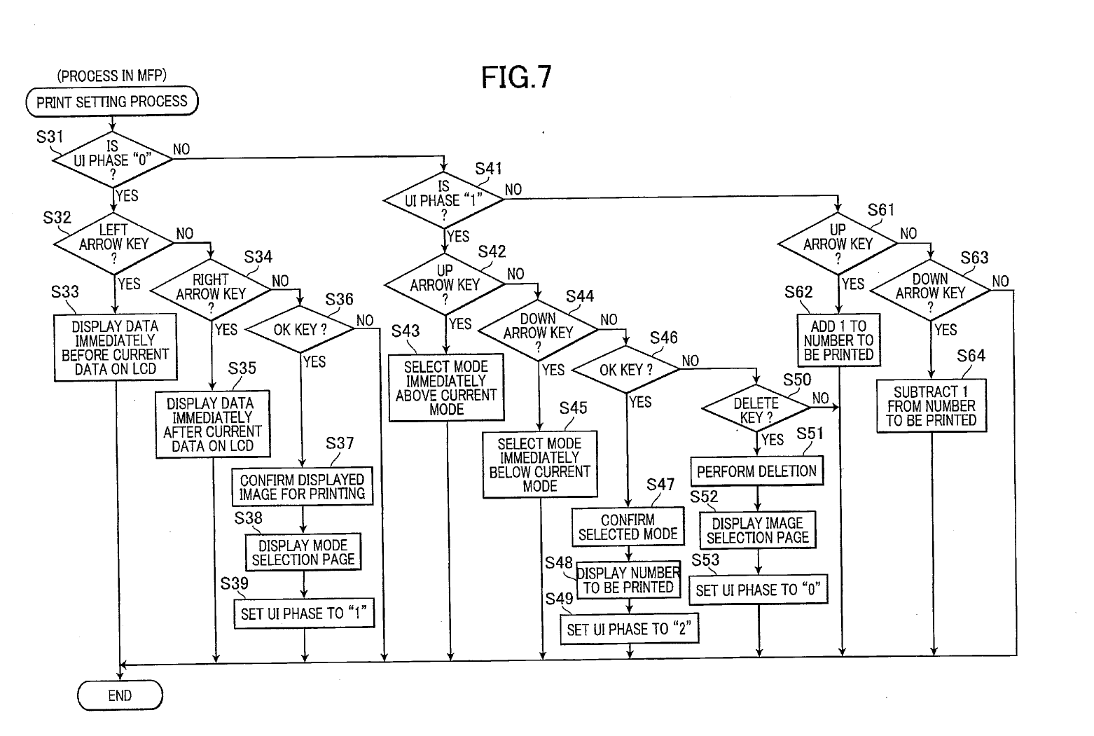

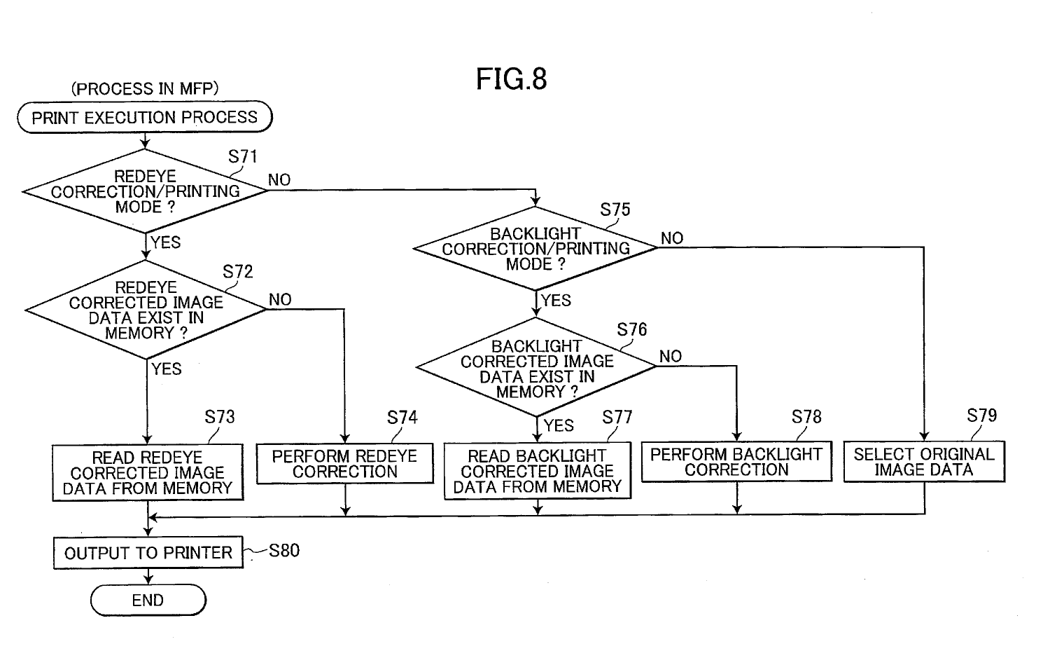

Next, processes performed by the CPU 21 will be described with reference to FIGS. 4 through 8. FIG. 4 and FIG. 5 are flowcharts showing a main task. FIG. 6 is a flowchart showing an image processing task. The CPU 21 performs the two processes by multitasking in a timesharing system. If the user requests that an image be printed in the main task, the image processing task is halted and only printing is performed. FIG. 7 is a flowchart showing a print setting process that is performed in the main task. FIG. 8 is a flowchart showing a print execution process that is also performed in the main task.

The main task is described with reference to the flowchart shown as FIG. 4. First, the CPU 21 determines whether the memory card 50 has been mounted in the slot section 72 (S1). If the memory card 50 has been mounted (S1: Yes), the CPU 21 determines whether the mounted memory card 50 stores original image data captured by a digital camera or the like (S2). If the memory card 50 has not been mounted (S1: No), or if the mounted memory card 50 stores no original image data (S2: No), the CPU 21 determines whether the user has instructed that another process such as a facsimile process be performed. If such an instruction has been provided, the corresponding process is executed (S3). The processing then returns to S1. In the embodiment, the memory card 50 stores only original image data, and no processed image data is stored in the memory card 50.

On the other hand, if the memory card 50 stores original image data (S2: Yes), the CPU 21 detects each size of a plurality of original image data stored in the memory card 50 (S4). The images sometimes have different data sizes due to the user's settings on image quality (normal, high, or the like). Each data size is stored in the header of each image data. Each data size is detected by reading the header of each image data.

Next, according to the detected data sizes, the CPU 21 determines the order of automatic image processing. In order to determine the order, the following two methods are available. In a first method, image processing is started from the image having the smallest data size. The image having the largest data size is the last to be processed. In a second method, image processing is started from the image having the largest data size. The image having the smallest data size is the last to be processed. The first method is advantageous in that image processing can be completed on a small-sized image in a shorter period of time, which means that a larger number of small-sized images can be processed within a given period of time, compared with large-sized images. Since image processing is performed on images from the smallest image in ascending order, processed image data can be created quickly. Therefore, when the user makes a request for printing, a higher ratio of the entire required process has already been completed.

On the other hand, the second method reduces the waiting time before printing. Specifically, an image having a large data size requires a longer time for image processing. If the user requests the printing of such a large-sized image, an image in a redeye-corrected state and if redeye correction is started after the user's request, the user has to wait for a long time. In this method, image processing is performed on images from one having the largest size in descending order. Hence, the waiting time can be reduced if the requested image has already been corrected at the point of the user's request. If the user instructs a small-sized image to be redeye-corrected for printing, the user does not have to wait so long even when the selected image has not been corrected yet, because a small-sized image requires a shorter time for image processing.

The processing order is determined in either one of the above two methods. The filenames of image data are sorted based on the determined processing order. The sorted filenames are stored in the processing order memory 23b (S5). Next, the image selection screen 45 shown in FIG. 3C is set on the display screen 41. The UI phase is set to “0”. The value of a processing order counter N is set to “0”. The redeye and backlight flags are set to “0” (S6) The UI phase is stored in the UI phase memory 23c. The redeye flag is stored in the redeye flag memory 23d. The backlight flag is stored in the backlight flag memory 23e. The processing order counter N is a value indicative of the current processing order stored in a predetermined register.

Next, the CPU 21 starts an image processing task that is executed in a timesharing system at the same time with the main task (S7). The CPU 21 adds 1 to the current value in the processing order counter N (S8). The original image data indicated by the processing order counter N is loaded from the memory card 50 into the image memory 23a (S9).

The CPU 21 determines whether the automatic redeye correction setting 43a (see FIG. 3B) is set to perform redeye correction (S10). If redeye correction is set to be performed (“ON”) (S10: Yes), a redeye correction instruction message is transmitted to the image processing task. The redeye correction instruction message is intended for instructing redeye correction to be started for the original image data stored in the image memory 23a. The redeye flag stored in the redeye flag memory 23d is set to “1” (S11).

If the automatic redeye correction setting 43a is not set to perform redeye correction (“OFF”) (S10: No) or if the process in S11 is completed, the CPU 21 then determines whether the automatic backlight correction setting 43b (see FIG. 3B) is set to perform backlight correction (S12). If automatic backlight correction is set to be performed (“ON”) (S12: Yes), a backlight correction instruction message is transmitted to the image processing task. The backlight correction instruction message instructs backlight correction to be started for the original image data stored in the image memory 23a. The backlight flag stored in the backlight flag memory 23e is set to “1” (S13).

If the automatic backlight correction setting 43b is not to set to perform backlight correction (“OFF”) (S12: No), or if the process in S13 is completed, the CPU 21 performs a print setting process (S14). In the print setting process, the user selects which image to be printed, and which mode to be used for printing. The print setting process will be described with reference to FIG. 7.

As the print setting process has completed, the CPU 21 determines whether the memory card 50 has been removed from the slot section 72 (S15). For a case in which the memory card 50 has been removed from the slot section 72 (S15: Yes), a description will be given later with reference to the flowchart shown in FIG. 5. If the memory card 50 is still mounted in the slot section 72 (S15: No), the CPU 21 determines whether a print start has been instructed, by detecting whether the user has depressed the start key 40d on the operation panel 4 (S16). If the start key 40d has been depressed, the CPU 21 determines that a print start has been instructed.

If a print start has been instructed (S16: Yes), a correction halt message for instructing halt of automatic image processing is transmitted to the image processing task (S17). For the steps after transmitting the correction halt message, a description will be given later with reference to FIG. 5.

If no print start has been instructed (S16: No), the CPU 21 then determines whether both the redeye and backlight flags are set to “0” (S18). In the image processing task, if redeye correction has been completed, the redeye flag is set to “0”. If backlight correction has been completed, the redeye flag is set to “0”. Therefore, if both the redeye and backlight flags are set to “0”, this indicates that both of the corrections required for the original image data stored in the image memory 23a have been completed.

If neither the redeye flag nor the backlight flag is “0” (S18: No), the processing returns to S14. If both of the redeye and backlight flags are “0” (S18: Yes), the CPU 21 updates the automatic correction status indicator 46 displayed on the display screen 41. Specifically, since image processing has been completed on a single original image data, the CPU 21 adds one to the number of corrected images, subtracts one from the number of unprocessed images, and displays a ratio between the numbers (S19).

Next, the CPU 21 determines whether there is uncorrected original image data left among a plurality of original image data stored in the memory card 50 (S20). If there is any uncorrected original image data left (S20: Yes), the processing returns to S8. If no uncorrected original image data is left (S20: No), an instruction for ending the image processing task is transmitted (S21). The steps subsequent to S21 (circled D) will be described with reference to the flowchart shown in FIG. 5.

FIG. 5 is a flowchart showing a remaining part of the main task. After the image processing task is halted in S21, a print setting process is performed (S22). The print setting process, which is the same as the process in S14, will be described later with reference to FIG. 7. When the print setting process is completed, the CPU 21 then determines whether the memory card 50 has been removed from the slot section 72 (S23). If the memory card 50 has not been removed from the slot section 72 yet (S23: No), the CPU 21 then determines whether the start of printing has been instructed (S24). Like S16, this determination is made by detecting whether the user has depressed the start key 40d provided on the operation panel 4. If the start key 40d has been depressed, the CPU 21 determines that the start of printing has been instructed.

If the start of printing has been instructed (S24: Yes), the CPU 21 executes printing (S25). Note that printing is also executed when the process in S17 of FIG. 4 is completed. The print execution process will be described later with reference to the flowchart in FIG. 8. When printing is completed, the CPU 21 displays the image selection screen 45 shown in FIG. 3C on the display screen 41, and sets the UI phase stored in the UI phase memory 3c to “0” (S26). Next, the CPU 21 determines whether there is unprocessed original image data left in the memory card 50 (S27). If there is no unprocessed original image data left (S27: No), the processing returns to S22. If any unprocessed original image data is left (S27: Yes), the processing returns to S7 shown as circled A in FIG. 4. On the other hand, in S15 of FIG. 4, if the memory card 50 has been removed from the slot section 72 (S15: Yes), as shown as circled B, a correction halt message for instructing the image processing task to halt image correction is transmitted (S28).

In the determination step of S23, if the memory card 50 has been removed from the slot section (S23: Yes), or if the processing in S28 is completed, all the processed image data stored in the image memory 23a is deleted (S29). Then, the processing returns to S1.

With reference to FIG. 6, the image processing task is described. FIG. 6 is a flowchart showing the image processing task. In the image processing task, first, the CPU 21 determines whether a redeye correction instruction message has been received. The redeye correction instruction message is intended for instructing redeye correction to be performed on the original image data stored in the image memory 23a (S101). If no redeye correction instruction message has been received (S101: No), the CPU 21 then determines whether a backlight correction instruction message has been received. The backlight correction instruction message is intended for instructing backlight correction to be performed on the original image data stored in the image memory 23a (S102). If no backlight correction instruction message has been received (S102: No), the processing returns to S101.

If a redeye correction instruction message has been received (S101: Yes), the CPU 21 determines whether the image memory 23a already stores redeye-corrected data created from the selected original image data (S103). If redeye correction has been performed, corrected image data is created; a filename (identifier) which indicates relationship with corresponding original image data is attached to the corrected image data; and the corrected image data is stored in the image memory 23a. Therefore, the CPU 21 determines whether a given processed image data corresponds to the selected original image data based on its filename. Note that the filename will be described later in detail.

If the image memory 23a stores no redeye-corrected data (S103: No), the image based on the original image data stored in the image memory 23a is divided into M-number of regions, and a number is assigned to each region from “1” in numeric order (S104). For example, the image is divided into 12 rectangles having three rows and four columns, like a lattice. In this case, M equals to “12”, so the numbers from “1” to “12” are assigned to the respective regions. Next, the CPU 21 sets the variable “k” for specifying one of the numbers assigned to the divided regions to “0” (S105). The variable is stored in a register.

Next, the CPU 21 determines whether the correction halt message for instructing the halt of automatic image processing has been received from the main task (S106). If the correction halt message has been received (S106: Yes), automatic image processing is halted and the image processing task ends. If no correction halt message has been received (S106: No), “1” is added to the variable “k” (S107). The redeye correction program 22b performs redeye correction on the divided region specified by the updated variable “k” (S108).

Next, the CPU 21 determines whether the variable “k” is equal to the number of the regions M, or, whether redeye correction has been completed on all the regions of the image (S109). If not completed yet (S109: No), the processing returns to S106. If completed (S109: Yes), the CPU 21 stores the redeye-corrected image data in the image memory 23a (S110). The redeye-corrected image data is stored with a filename which indicates relationship with the corresponding original image data.

Two ways are described on how to create a filename. A first way is to add a name (or abbreviation, symbol, etc.) of the processing performed on original image data, to a filename of original image data. For example, if the filename of original image data is “PIC0001.jpg”, a filename of its redeye-corrected data will be “PIC0001_redeye.jpg”. The filename is thus created by adding “redeye” representing redeye correction, to the filename of original image data. In addition, a filename of backlight-corrected data will be “PIC0001_backlit.jpg”, for example. This filename is created by adding “backlit” representing backlight correction, to the filename of original image data.

A second way is to store files in folders. For example, an original image folder for storing original image data is named “100BRO”, a redeye-corrected image folder for storing redeye-corrected image data is named “REDEYE”, and a backlight-corrected image folder for storing backlight-corrected image data is named “BACKLIT”. Files stored in these folders may have the same filename for original image, redeye-corrected image, and backlight-corrected image (for example, PIC0001.jpg for the original image, redeye-corrected image, and backlight-corrected image). In this case, a substantial filename includes the name of the folder in which the file is stored. For example, although both redeye-corrected image data and backlight-corrected image data are displayed to have the same filename “PIC0001” within their respective folders, the redeye-corrected data and the backlight-corrected data are distinguishable from each other, based on the names of the folders which store the respective data.

If the processing in S110 ends, or if redeye-corrected image data already exists (S103: Yes), the CPU 21 sets the redeye flag stored in the redeye flag memory 23d to “0” (S111), and returns to S101.

In S102, if any backlight correction instruction message has been received (S102: Yes), the CPU 21 determines whether the image memory 23a already stores backlight-corrected data corresponding to the specified original image data (S121). As described above, this determination is made by examining the filename of backlight-corrected image. If the name of a backlight-corrected image file includes a filename of original image data, this indicates that the file stores backlight-corrected image data corresponding to the original image data. If no file includes the filename of original image data, this indicates that the backlight-corrected image data corresponding to the original image data does not exist in the image memory 23a. If image data files are managed in folders, a folder for storing backlight-corrected image data is searched. If any filename identical with the filename of original image data is found, the CPU 21 determines that the folder stores corrected image data.

If the image memory 23a stores no backlight-corrected data (S121: No), an image based on original image data is divided into M-number of regions, and a number is assigned to each region from “1” in numeric order (S122). This method is the same as in the case of redeye correction, and its detailed description is omitted here. Next, the variable “k” is set to “O” (S123). The CPU 21 then determines whether a correction halt message for instructing halt of automatic image processing has been received from the main task (S124). If the correction halt message has been received (S124: Yes), automatic image processing is halted so that the image processing task ends. If no correction halt message has been received (S124: No), the CPU 21 adds “1” to the variable “k” (S125). The backlight correction program 22c performs backlight correction on the divided region specified by the updated variable “k” (S126).

Next, the CPU 21 determines whether the variable “k” equals to the number of the regions M, that is, whether backlight correction has been completed on all the regions of the image (S127). If not completed yet (S127: NO), the processing returns to S124. If completed (S127: Yes), the CPU 21 stores the backlight-corrected data in the image memory 23a (S128). The filename that is attached to the backlight-corrected data is the same as in the case of redeye correction, and its detailed description is omitted here.

If the processing in S128 is completed, or if the image memory 23a already stores backlight-corrected data (S121: Yes), the CPU 21 sets the backlight flag stored in the backlight flag memory 23a to “0” (S129), and returns to S101.

A print setting process is described with reference to FIG. 7. The print setting process corresponds to S14 and S22 of the main task shown in FIG. 4 and FIG. 5. In the print setting process, first, the CPU 21 determines whether the UI phase stored in the UI phase memory 23c is “0” (S31). If the UI phase is “0”, this indicates that the display screen 41 is currently displaying the image selection screen 45. Thus, if the UI phase is “0” (S31: Yes), the CPU 21 determines whether the left arrow key of the cursor key 40a has been operated (S32). If the left arrow key has been operated (S32: Yes), image data immediately before image data corresponding to an image currently displayed in the left half 44 of the display screen 41 is read from the memory card 50, and the read image is displayed in the left half 44 (S33). If the left arrow key of the cursor key 40a has not been operated (S32: No), the CPU 21 then determines whether the right arrow key of the cursor key 40a has been operated (S34). If the right arrow key has been operated (S34: Yes), original image data immediately after original image data corresponding to the image currently displayed in the left half 44 of the display screen 41 is read from the memory card 50 so that the read image is displayed in the left half 44 (S35). If the right arrow key has not been operated (S34: No), the CPU 21 then determines whether the OK key 40c has been operated (S36). If the OK key 40c has been operated (S36: Yes), this operation confirms the image currently displayed in the left half 44 as a selected image (S37). The display screen 41 displays the mode selection screen 47 (FIG. 3D) (S38). The CPU 21 sets the UI phase stored in the UI phase memory 23c to “1”. When either S33 or S35 is completed, or if the OK key 40c has not been operated (S36: No), the print setting process ends.

If the UI phase stored in the UI phase memory 23c is not “0” (S31: No), the CPU 21 determines whether the UI phase is “1” (S41). If the UI phase is “1” (S41: Yes), the CPU 21 determines whether the up arrow key of the cursor key 40a has been operated (S42). If the up arrow key has been operated (S42: Yes), a processing mode displayed immediately above a currently selected processing mode is selected (S43). If the currently selected processing mode is displayed on the top, the current selection is not changed. If the up arrow key has not been operated (S42: No), the CPU 21 determines whether the down arrow key has been operated (S44). If the down arrow key has been operated (S44: Yes), a processing mode displayed immediately below the currently selected processing mode is selected (S45). If the currently selected processing mode is displayed at the bottom, the current selection is not changed.

If the down arrow key has not been operated (S44: No), the CPU 21 then determines whether the OK key 40c has been operated (S46). If the OK key 40c has been operated (S46: Yes), this operation confirms the currently selected processing mode (S47). The display screen 41 displays the sheet number input screen 48 (FIG. 3E) (S48). The CPU 21 sets the UI phase stored in the UI phase memory 23c to “2”. If the OK key 40c has not been operated (S46: No), the CPU 21 then determines whether the delete key 40e has been operated (S50). If the delete key 40e has been operated, the selected original image data (which has been confirmed in S37) is deleted from the memory card 50. At the same time, if the processed image data obtained by performing redeye correction or backlight correction on the confirmed original image data is stored in the image memory 23a, the processed image data is also deleted (erased) (S51) As described above, the processed image data corresponding to its original image data has a filename which associates the processed image data with the original image data. A search is conducted based on the filename. When the deletion process in S51 is completed, the CPU 21 displays the image selection screen 45 on the display screen 41 (FIG. 3C) (S52). The CPU 21 sets the UI phase stored in the UI phase memory 23c to “0” (S53). If one of S43, S45, S49, or S53 is completed, or if the delete key 40e is not operated in S50, the print setting process ends.

In S41, if the UI phase stored in the UI phase memory 23c is not “1” (S41: No), the CPU 21 determines that the UI phase is “2”. The CPU 21 then determines whether the up arrow key has been operated (S61). If the up arrow key has been operated (S61: Yes), the CPU 21 adds “1” to the value currently displayed in the number of sheets to be printed 48a, and displays the updated value in the number of sheets to be printed 48a (S62). If the up arrow key has not been operated (S61: No), the CPU 21 determines whether the down arrow key has been operated (S63). If the down arrow key has been operated (S63: Yes), the CPU 21 subtracts “1” from the value currently displayed in the number of sheets to be printed 48a, and displays the updated value in the number of sheets to be printed 48a (S64). Note that the value of the number of sheets to be printed 48a does not become smaller than “1”. When either S62 or S64 is completed, or if the down arrow key is not operated (S63: No), the print setting process ends.

A print execution process is described with reference to FIG. 8. FIG. 8 is a flowchart showing the print execution process. The print execution process corresponds to S25 of the main task shown in FIG. 4 and FIG. 5. In the print execution process, the CPU 21 determines whether the processing mode selected on the mode selection screen 47 is the redeye correction/printing mode 47 (S71). If the selected processing mode is the redeye correction/printing mode 47b (S71: Yes), the CPU 21 determines whether the image memory 23a stores redeye-corrected data corresponding to selected original image data (S72). This determination is made by searching processed image data stored in the image memory 23a, for the data which has the filename corresponding to a filename of original image data. If the image memory 23a stores the redeye-corrected data corresponding to the filename of original image data (S72: Yes), the CPU 21 reads the redeye-corrected data from the image memory 23a (S73), and outputs the data to the printer 2 (S80). If the image memory 23a does not store the redeye-corrected data corresponding to the filename of original image data (S72: No), the CPU 21 starts the redeye correction program 22b to perform redeye correction on the original image data (S74). When the redeye correction is completed, the CPU 21 stores the redeye-corrected data in the image memory 23a, and outputs the data to the printer 2 (S80).

On the other hand, if the processing mode selected on the mode selection screen 47 is the redeye correction/printing mode 47b (S71: No), the CPU 21 determines whether the selected processing mode is the backlight correction/printing mode 47c (S75). If the selected processing mode is the backlight correction/printing mode 47c (S75: Yes), the CPU 21 determines whether the image memory 23a stores backlight-corrected data corresponding to the selected original image data (S76). This determination is made by searching processed image data stored in the image memory 23a, for the data which has a filename corresponding to a filename of original image data. If the image memory 23a stores the backlight-corrected data corresponding to the filename of original image data (S76: Yes), the CPU 21 reads the backlight-corrected data from the image memory 23a (S77), and outputs the data to the printer 2 (S80). If the image memory 23a does not store the backlight-corrected data corresponding to the filename of original image data (S76: No), the CPU 21 starts the backlight correction program 22c to perform backlight correction on the original image data (S78). When the backlight correction is completed, the CPU 21 stores the backlight-corrected data in the image memory 23a, and outputs the data to the printer 2 (S80).

In S75, if the processing mode selected on the mode selection screen 47 is not the backlight correction/printing mode 47c (S75: No), this indicates that the selected processing mode is the normal printing mode 47a. The CPU 21 selects original image data (S79), and outputs the original image data to the printer 2 (S80). In S80, the CPU 21 outputs either original image data or processed image data to the printer 2, and transmits to the printer 2 an instruction for starting printing.

As described above, the print execution process is performed after automatic image processing (which is started when the memory card 50 is mounted in the slot section 72) is halted. Therefore, the print execution process can be performed quickly. Particularly, when the user requests for printing processed image data but the processed image data has not been created yet, the processed image data requested by the user can be created quickly because the automatic image processing is halted.

As described above, when the memory card 50 is mounted in the slot section 72 of the MFP 1, if the memory card 50 stores original image data, image processing is automatically started. When the user instructs processed image to be printed, image processing is halted, and the memory is searched for processed data. If processed image data is found in the memory, printing is executed based on the processed image data. Therefore, printing can be executed more quickly than the case in which image processing is performed in response to the user's request and in which printing is executed after image processing is completed. In addition, since the automatic image processing is halted so that normal processing according to the user's request is given a higher priority, the normal processing is performed quickly.

According to the image processing device of the embodiment (i.e., the MFP 1), when an external storage medium storing image data is mounted, it is detected that the external storage medium has been mounted. Then, a start of a predetermined image process on the image data is instructed. Since the predetermined image process is started in response to the instruction, the predetermined image process is already in progress when the user requests processed image data. Therefore, the image processing device can deliver the processed image data within a shorter period of time.

If the user instructs a normal process other than the predetermined image process in a state that the external storage medium is mounted and the predetermined image process has already been started, the predetermined image process in progress is halted. Therefore, a higher priority is given to the normal process instructed by the user. This plurality of kinds of processes can be performed by a CPU or the like in a timesharing system. However, in order to perform the plurality of kinds of processes in a timesharing system, each processing speed is lowered. The image processing device according to the embodiment can perform the normal process more quickly because the image processing device halts the predetermined image process in progress and performs the normal process. Therefore, the image processing device can deliver processed image data within a shorter period of time, and can also respond to a user's instruction more quickly.

According to the image processing device of the embodiment, it is regularly checked whether the normal process has been instructed. When it is found that the normal process has been instructed, the start of the normal process is instructed. Therefore, the image processing device can quickly find instruction by the user for starting the normal process, so that the normal process can be performed quickly in response to the user's instruction.

When the external storage medium is mounted, the user most often instructs printing of the image data stored in the external storage medium. When such a printing instruction is made, the predetermined image process in progress is halted. Therefore, the image processing device can execute printing quickly in response to the printing instruction.

When any one of image data stored in the external storage medium is selected, the image based on the selected image data is displayed on a display portion. Hence, the user can arbitrarily select image data and can visually check the selected image data by displaying the corresponding image on the display portion.

The image processing device of the embodiment can set whether the predetermined image process is started when the external storage medium is mounted. Therefore, if the user does not wish to start the predetermined image process when the external storage medium is mounted, the user can make such a setting.

Further, the image processing device can perform a plurality of kinds of image processes, and can set whether each image process is started when the external storage medium is mounted. If the user does not wish to start any one of image processes when the external storage medium is mounted, the user can make such a setting.

When the predetermined image process of the image data stored in the external storage medium is completed, the processed image data is stored in the external storage medium. If the processed image data is stored in a storage means other than the external storage medium, the predetermined image process has to be performed again when the external storage medium is mounted in another device, which is time-consuming. However, according to the image processing device of the embodiment, the external storage medium also stores the processed image data. Thus, even if the external storage medium is mounted in another device, the processed image data can be obtained quickly.

Alternatively, processed image data may be stored in the internal storage portion. Since processed image data is not stored in the external storage medium, storage space on the external storage medium can be saved. In addition, processed image data can be stored even when there is not enough storage space in the external storage medium. Further, since the internal storage portion is accessed more quickly, processed image data can be read or written more quickly.

When the image processing device reads original image data in the external storage medium into an internal RAM or the like for performing the predetermined image process, the image processing device either deletes the original image data in the external storage medium or keeps the original image data in the external storage medium as it is. When the image processing device deletes the original image data in the external storage medium, the image processing device restores the original image data in the external storage medium. When the image processing device keeps the original image data in the external storage medium, the original image data remains in the external storage medium. On the other hand, processed image data is stored in either the external storage medium or the internal storage portion. The predetermined image process usually improves image quality, but occasionally degrades image quality. However, by restoring the original image data in the external storage medium or by keeping the original image data in the external storage medium, the original image data having original image quality can be maintained.

According to the image processing device of the embodiment, processed image data is stored with an identifier that indicates the relation with corresponding original image data stored in the external storage medium. By specifying either one of original image data or processed image data, image data corresponding to the specified image data can be extracted easily.

The image processing device of the embodiment can perform redeye correction for preventing eyes of a person in an image from being displayed in red, and/or backlight correction for preventing backlit object in an image from being displayed unclearly. Since these corrections have to undergo complex steps, a particularly long time is required. However, since the predetermined image process is automatically started when the external storage medium is mounted, the image processing device can deliver processed image data quickly upon user's request for processed image data.

Further, according to the image processing device of the embodiment, one of original image data stored in the external storage medium is selected, and printing of the selected original image data is instructed. Upon the instruction, the image processing device searches the external storage medium or the internal storage portion for processed image data corresponding to the selected original image data based on the identifier, and subsequently prints the found processed image data. Since processed image data has its own identifier which indicates corresponding original image data, corresponding processed image data can be found easily based on its identifier. If the corresponding processed image data is already stored, the image processing device prints an image based on the corresponding processed image data. Therefore, the image processing device can execute printing more quickly than in a case in which the predetermined image process is performed after the user makes a request for printing.

When the external storage medium is mounted, the predetermined image process is automatically started on the original image data stored in the external storage medium. When printing of image data is instructed, the predetermined image process is halted, and either the external storage medium or the internal storage portion is searched for processed image data corresponding to original image data selected by the user. If the processed image data corresponding to the original image data is not found in either the external storage medium or the internal storage portion, an image process on the selected original image data is performed. In this case, since the predetermined image process automatically started when the external storage medium is mounted has been halted, the image processing device can perform the image process on the selected original image data quickly and can perform printing.

According to the image processing device of the embodiment, the user can select and erase original image data. The image processing device searches the external storage medium or the internal storage portion for processed image data corresponding to the selected original image data based on the identifier of the processed image data, and then erases the found processed image data. When the selected original image data is erased, this indicates that the processed image data corresponding to the selected original image data is not required anymore. Since the image processing device also erases the corresponding processed image data, the user does not have to give erasing instructions both to original image data and processed image data corresponding to the original image data. This improves the usability of the image processing device.

The image processing device of the embodiment detects each data size of a plurality of image data stored in the external storage medium, and determines an order for performing the predetermined image process according to the detected data sizes. The predetermined image process is performed on the plurality of image data in the determined order. The data size becomes larger, the longer time image processing takes. Therefore, when the predetermined image process is performed in ascending order based on data size (beginning from small image data), a larger number of images can be processed within a given period of time, than in descending order based on data size (beginning from large image data). Therefore, when the user requests the image processing device to produce processed image data, it is likely that the processed image data has already been produced.

Large image data requires a longer time for processing. If the user requests for processing large image data and if the image data has not been processed yet, the predetermined image process is started upon this instruction and the user needs to wait for a long time. On the other hand, the time required for processing small image data is shorter. If the user requests for processing small image data and if the image data has not been processed yet, the user need not wait for such a long time. Therefore, when the predetermined image process is performed in descending order based on data size (from large image data), the predetermined image process is begun from the image data requiring the longest waiting time (from the largest image data). Hence, it is likely that the image processing device can reduce waiting time of the user.

According to the image processing device of the embodiment, a ratio of the number of processed image data to the total number of image data stored in the external storage medium. Therefore, the user can visually check the status of processing of the image data stored in the external storage medium.

While the invention has been described in detail with reference to the above aspects thereof, it would be apparent to those skilled in the art that various changes and modifications may be made therein without departing from the scope of the claims.

For example, the image processing device according to the above-described embodiment relates to the multifunction peripheral (MFP) 1. However, the image processing device may be a single-function printer, a computer having a memory card reader, or the like.

Further, in the above-described embodiment, the normal processing is a process that is performed when the user has requested printing. However, the normal processing may instead be image processing, such as backlight correction or redeye correction, that is executed when the user has requested the image processing on an image selected arbitrarily by the user.

Further, the RAM 23 stores processed image data in the above-described embodiment. However, the memory card 50 may store processed image data. Alternatively, the image processing device may be configured in such a manner that the memory card 50 stores processed image data when the memory card 50 has a sufficient free space, and that the RAM 23 stores processed image data when the memory card 50 does not have a sufficient free space.

What is claimed is:

1. An image processing device comprising:
a mounting portion that is configured to detachably mount an external storage medium storing image data;
an image processing portion that performs a predetermined image process on the image data stored in the external storage medium;
a normal processing portion that performs a normal process other than the predetermined image process;
a detecting portion that detects that the external storage medium is mounted in the mounting portion;
an image-process instructing portion that instructs the image processing portion to start the predetermined image process if the detecting portion detects that the external storage medium is mounted in the mounting portion;
a normal-process instructing portion that instructs the normal processing portion to start the normal process; and
a control portion that instructs the image processing portion to halt the predetermined image process and that instructs the normal processing portion to start the normal process, if the normal-process instructing portion instructs the normal processing portion to start the normal process during a time that the image processing portion is performing the predetermined image process.

2. The image processing device according to claim 1, further comprising a checking portion that regularly checks whether start of the normal process has been instructed,
wherein the normal-process instructing portion instructs the normal processing portion to start the normal process if the checking portion finds that the normal-process instructing portion has instructed the start of the normal process.

3. The image processing device according to claim 1, wherein the normal-process instructing portion includes a print instructing portion that instructs printing of image data; and
wherein the control portion instructs the image processing portion to halt the predetermined image process if the print instructing portion instructs printing of the image data.

4. The image processing device according to claim 1, further comprising:
a display portion that displays an image based on image data; and
a selecting portion that selects image data from among a plurality of image data stored in the external storage medium; and
a display control portion that controls the display portion to display an image based on the image data selected by the selecting portion.

5. The image processing device according to claim 1, further comprising a setting portion that sets whether the image-process instructing portion instructs start of the predetermined image process when the external storage medium is mounted in the mounting portion.

6. The image processing device according to claim 5, wherein the predetermined image process includes a plurality of kinds of image processes; and
wherein the setting portion sets whether the image-process instructing portion instructs start of each of the plurality of kinds of image processes.

7. The image processing device according to claim 1, further comprising a storage control portion that stores processed image data in the external storage medium, if the image processing portion completes the predetermined image process of the image data stored in the external storage medium.

8. The image processing device according to claim 1, further comprising:
an internal storage portion that stores image data; and
a storage control portion that stores processed image data in the internal storage portion, if the image processing portion completes the predetermined image process of the image data stored in the external storage medium.

9. The image processing device according to claim 7, wherein, if the image processing portion completes the predetermined image process, the storage control portion stores in the external storage medium original image data corresponding to the processed image data, and stores the processed image data in either one of the external storage medium and the internal storage portion.

10. The image processing device according to claim 9, wherein the storage control portion stores the processed image data with an identifier indicative of a relation with corresponding original image data stored in the external storage medium.

11. The image processing device according to claim 1, wherein the predetermined image process includes at least one of a redeye correction process and a backlight correction process, the redeye correction process preventing eyes of a person or animal in an image from being displayed in red, the backlight correction process preventing a backlit object in an image from being displayed unclear.

12. The image processing device according to claim 10, further comprising a selecting portion that selects original image data from among a plurality of original image data stored in the external storage medium,
wherein the normal-process instructing portion comprises a print instructing portion that instructs printing of image data; and
wherein the normal processing portion comprises:
a searching portion that searches either one of the external storage medium and the internal storage portion for processed image data corresponding to the original image data selected by the selecting portion based on the identifier, if the print instructing portion instructs printing of the processed image data; and
a printing portion that executes printing based on the processed image data searched by the searching portion.

13. The image processing device according to claim 12, wherein the normal processing portion further comprises a normal-image-process instructing portion that instructs the image processing portion to perform the predetermined image process on the original image data selected by the selecting portion, if processed image data corresponding to the original image data is not stored in the either one of the external storage medium and the internal storage portion.

14. The image processing device according to claim 10, further comprising:
a deletion instructing portion that instructs deletion of image data; and
a deleting portion that deletes the original image data selected by the selecting portion and stored in the external storage medium, that searches either one of the external storage medium and the internal storage portion for processed image data corresponding to the original image data based on the identifier, and that deletes the processed image data, if the deletion instructing portion instructs deletion of the original image data.

15. The image processing device according to claim 1, further comprising:
a data-size detecting portion that detects respective data sizes of a plurality of image data stored in the external storage medium; and
a process-order setting portion that sets an order of the predetermined image process according to the data sizes detected by the data-size detecting portion,
wherein the image processing portion performs the predetermined image process on the plurality of image data in the order set by the process-order setting portion.

16. The image processing device according to claim 1, further comprising a progress-status displaying portion that displays a ratio of a number of image data processed by the image processing portion to a total number of image data stored in the external storage medium.

17. A computer readable product storing a set of program instructions executable on an image processing device, the set of program instructions comprising:
detecting that an external storage medium is mounted on an image processing device;
instructing start of a predetermined image process on image data stored in the external storage medium if the external storage medium is mounted;
performing the predetermined image process;
detecting that start of a normal process is instructed, the normal process being other than the predetermined image process; and
halting the predetermined image process and starting the normal process, if the start of the normal process is instructed during a time that the predetermined image process is being performed.

18. The computer readable product according to claim 17, wherein the set of program instructions further comprises checking regularly whether start of the normal process has been instructed.

19. The computer readable product according to claim 17, wherein the set of program instructions further comprises setting whether start of the predetermined image process is instructed when the external storage medium is mounted.

20. The computer readable product according to claim 17, wherein the set of program instructions further comprises storing processed image data in either one of the external storage medium and an internal storage portion if the predetermined image process of the image data stored in the external storage medium is completed, the processed image data being stored with an identifier indicative of a relation with corresponding image data stored in the external storage medium.
